(19) United States
(12) Patent Application Publication
(10) Pub. No.: US 2026/0174063 A1
(43) Pub. Date: Jun. 25, 2026

(54) Chew Toy Device for Dogs

(71) Applicant: Mark Hallam, Sarcoxie, MO (US)

(72) Inventor: Mark Hallam, Sarcoxie, MO (US)

(21) Appl. No.: 19/365,846

(22) Filed: Oct. 22, 2025

Related U.S. Application Data
(60) Provisional application No. 63/737,926, filed on Dec. 23, 2024.

(51) Int. Cl. A01K 15/02

(52) U.S. Cl. CPC A01K 15/026

(57) ABSTRACT

A durable dog chew toy comprising a body made from non-toxic, edible rubber for ergonomic handling and extended chewing is disclosed. The body features sinusoidal grooves on a major surface and uniformly spaced rectangular ridges on at least one side surface, both mimicking a tire tread pattern to enhance grip, stimulate gums, and promote canine dental hygiene. In one embodiment, the chew toy includes a multi-layer construction with a food-grade rubber outer layer, a scented foam middle layer infused with edible flavors, and a solid rubber inner core to resist collapse. The chew toy can be frozen for teething relief. Additionally, the toy can be sold in reusable, resealable packaging made from edible material, enabling safe storage and branding.

### CROSS-REFERENCE TO RELATED APPLICATION

The present application claims priority to, and the benefit of, U.S. Provisional Application No. 63/737,926, which was filed on Dec. 23, 2024, and is incorporated herein by reference in its entirety.

### FIELD OF THE INVENTION

The present invention generally relates to the field of pet products. More specifically, the present invention relates to a durable dog chew toy configured for safe, extended, and engaging use by domestic canines. The chew toy features a unique tread-inspired texture that includes sinusoidal grooves and rectangular ridges to promote oral health and enhance grip. The device is dimensioned to accommodate various jaw sizes and chewing behaviors and may be constructed as a solid or hollow structure for customized weight and flexibility. Accordingly, the present disclosure makes specific reference thereto. Nonetheless, it is to be appreciated that aspects of the present invention are also equally applicable to other like applications, devices, and methods of manufacture.

### BACKGROUND

By way of background, pets and especially dogs are naturally inclined to chew as a form of play, stress relief, and dental maintenance. A wide variety of chew toys are available for providing relief to dogs. However, a persistent problem exists in the durability and longevity of conventional chewing toys. Many conventional dog chew toys, particularly those constructed from plastic or standard-grade rubber, are prone to rapid wear and damage. Active or aggressive chewers can destroy such toys within minutes, resulting in frustration for the pet and potential hazards such as ingestion of torn materials.

Moreover, once a toy is rendered unusable, dogs may become bored or anxious, leading them to redirect their chewing behavior toward inappropriate household items such as furniture, shoes, or cords. The lack of sufficiently resilient chew toys not only compromises pet safety and dental health but also leads to increased costs and inconvenience for pet owners. Accordingly, individuals desire a more durable, safe, and engaging chew toy solution.

Therefore, there exists a long-felt need in the art for a dog chew toy that overcomes the limitations of conventional dog toys that are easily damaged, hazardous, or unengaging. There is a long-felt need for a chew toy that is durable enough to withstand prolonged and aggressive chewing behavior exhibited by dogs of various breeds and sizes. In addition, there is a long-felt need for a chew toy that enhances pet safety, minimizes choking hazards, and eliminates the risk of ingestion of harmful fragments. There is also a long-felt need for a chew toy that provides an enriched sensory experience to maintain a dog's attention and reduce destructive behavior caused by boredom. Furthermore, there is a long-felt need for a chew toy that contributes to oral health by promoting gum stimulation and helping to remove plaque buildup. Finally, there is a long-felt need in the art for a dog chew toy that is both functionally engaging and constructed from safe, non-toxic, and edible materials that ensure long-term use without harming the pet.

The subject matter disclosed and claimed herein, in one embodiment, comprises a durable dog chew toy formed from a monolithic body of edible, non-toxic rubber. The chew toy is dimensioned for ergonomic handling, with a length ranging from 5.00 inches to 7.00 inches, a width ranging from 0.50 inches to 1.50 inches, and a thickness ranging from 0.50 inches to 1.50 inches. A first major surface of the toy includes a plurality of evenly spaced, laterally oriented sinusoidal grooves designed to stimulate the dog's gums and enhance tactile feedback. At least one side surface of the toy includes a series of rectangular ridges configured to provide traction for the dog's teeth and promote dental hygiene by scraping the surface of the teeth during chewing. The chew toy is constructed to mimic a tire tread pattern, which both appeals visually and improves grip for both the dog and the handler.

In another embodiment, the chew toy comprises a multi-layered structure that includes an outer layer of food-grade natural rubber, a middle layer of scented or flavored foam infused with one or more edible flavorings such as beef, chicken, or mint, and an inner core of solid rubber. The toy may also incorporate a hollow internal chamber adapted to hold edible treats, which are released through openings in the body when the dog applies chewing pressure.

In this manner, the durable dog chew toy of the present invention satisfies the long-felt need for a highly resilient, interactive, and safe chew solution for dogs. The design enhances chewing satisfaction, improves oral hygiene, prevents toy disintegration, and supports safe and hygienic use over long periods. The chew toy may be further enhanced with scent, flavor, and treat-dispensing features, making it ideal for pet owners seeking a multifunctional, long-lasting alternative to traditional toys. The chew toy is suitable for home use, training, pet therapy, and commercial sale, and may be packaged in reusable, edible containers for convenience, sustainability, and branding.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a durable dog chew toy. The durable dog chew toy comprises a monolithic body made from a durable, non-toxic, and edible rubber, a first major surface of the body includes a plurality of evenly spaced, laterally oriented, sinusoidal grooves configured to provide enhanced chewing stimulation and promote gum health, wherein at least one lateral surface of the body includes a plurality of uniformly spaced rectangular ridges, the grooves, and the ridges are configured to mimic a tire tread pattern to provide a textured grip surface for a dog, and wherein the body includes beveled side edges and has a Shore A hardness rating between 80 and 95 to prevent oral injury and increase durability.

In another aspect, a durable dog chew toy is disclosed. The durable dog chew toy includes an outer layer formed of non-toxic, food-grade natural rubber, a middle layer disposed beneath the outer layer, the middle layer comprising a scented foam material infused with at least one edible flavoring selected from the group consisting of beef, chicken, and mint, an inner core formed of solid rubber and configured to resist collapse under chewing pressure while providing a resilient, squeeze-back feel, wherein the chew toy is shaped as a rectangular prism and includes a plurality of sinusoidal grooves on a first surface and rectangular ridges on at least one lateral surface, and wherein the chew toy is adapted for repeated chewing without structural degradation.

In another embodiment, a packaging in the form of a resealable bag is configured to store at least one dog chew toy, the chew toy comprises a body made of edible rubber with sinusoidal grooves and rectangular ridges formed on its surfaces. The bag includes branding indicia and a resealable fastener selected from a group consisting of a zip lock, adhesive strip, or fold-over clasp, wherein the bag is reusable for storage of chew toys after initial opening.

In one embodiment, the grooves being further adapted to retain edible pastes or flavoring substances for extended canine engagement.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of durable dog chew toy of the present invention in accordance with the disclosed structure;

FIG. 2 illustrates a perspective view showing a dog chewing the durable chew toy of the present invention in accordance with the disclosed structure;

FIG. 3 illustrates a perspective view of one potential embodiment of packaging of the chew toy of the present invention in accordance with the disclosed structure; and

FIG. 4 illustrates a cross-sectional view of one embodiment of the durable chew toy of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a dog chew toy that overcomes the limitations of conventional dog toys that are easily damaged, hazardous, or unengaging. There is a long-felt need for a chew toy that is durable enough to withstand prolonged and aggressive chewing behavior exhibited by dogs of various breeds and sizes. In addition, there is a long-felt need for a chew toy that enhances pet safety, minimizes choking hazards, and eliminates the risk of ingestion of harmful fragments. There is also a long-felt need for a chew toy that provides an enriched sensory experience to maintain a dog's attention and reduce destructive behavior caused by boredom. Furthermore, there is a long-felt need for a chew toy that contributes to oral health by promoting gum stimulation and helping to remove plaque buildup. Finally, there is a long-felt need in the art for a dog chew toy that is both functionally engaging and constructed from safe, non-toxic, and edible materials that ensure long-term use without harming the pet.

The present invention, in one exemplary embodiment, is a durable dog chew toy. The durable dog chew toy includes an outer layer formed of non-toxic, food-grade natural rubber, a middle layer disposed beneath the outer layer, the middle layer comprising a scented foam material infused with at least one edible flavoring selected from the group consisting of beef, chicken, and mint, an inner core formed of solid rubber and configured to resist collapse under chewing pressure while providing a resilient, squeeze-back feel, wherein the chew toy is shaped as a rectangular prism and includes a plurality of sinusoidal grooves on a first surface and rectangular ridges on at least one lateral surface, and wherein the chew toy is adapted for repeated chewing without structural degradation.

Reference will now be made in detail to the present preferred embodiments of the invention, examples of which are illustrated in the accompanying drawings. Wherever possible, the same reference numerals are used in the drawings and the description to refer to the same or like parts.

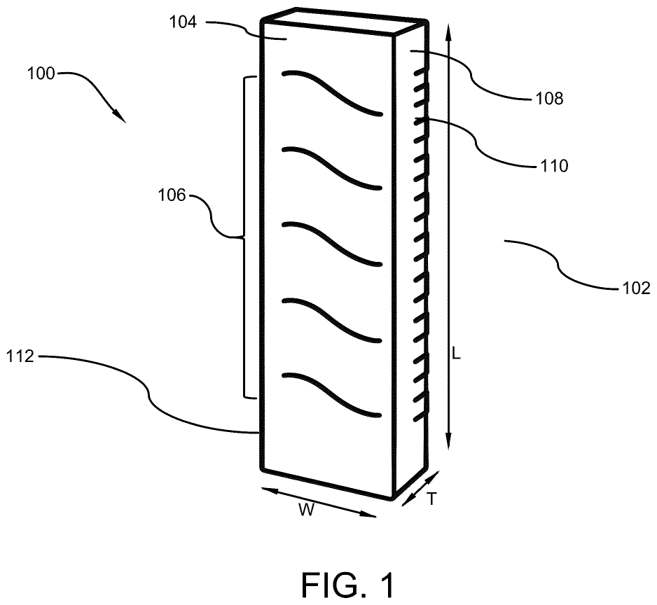

Referring initially to the drawings, FIG. 1 illustrates a perspective view of one potential embodiment of durable dog chew toy of the present invention in accordance with the disclosed structure. The durable dog chew toy 100 of the present invention is designed as an improved version of conventional dog toys, for enhancing longevity, safety, and enjoyment for pets. The durable dog chew toy 100 is adapted to withstand extended chewing sessions by dogs. More specifically, the chew toy 100 has, in one embodiment, a monolithic body 102 made from a durable, non-toxic, and edible rubber, preferably, retread tire rubber that goes on a conventional tire for recapping. The body 102 has a length “L” ranging from 5.00 inches to 7.00 inches, a width “W” ranging from 0.50 inches to 1.50 inches, and a thickness “T” ranging from 0.50 inches to 1.50 inches. The main body 102 is rectilinear in shape and can be solid in one embodiment, or in another embodiment hollow to accommodate requirements of different users for weight and flexibility balances.

A first major surface 104 of the body 102 includes a plurality of evenly spaced, laterally oriented, sinusoidal grooves 106 disposed therein. The sinusoidal texture of the first major surface 104 offers an enhanced chewing experience compared to a flat surface. The grooves 106 also gently stimulate the gums of a chewing pet, such as a dog, thereby promoting blood circulation and reducing inflammation.

At least one side or lateral surface 108 of the body 102 includes a plurality of uniformly spaced rectangular teeth or ridges 110. Each ridge of the plurality of ridges 110 have a width of about 0.05 inch to about 0.08 inch and a protrusion height of about 0.06 inch to about 0.09 inch. The ridges provide traction points for the dog's teeth, preventing slipping while chewing and scrape against the dog's teeth during chewing, helping dislodge buildup. Both the ridges 110 and the grooves 106 help the dog to grip the chew toy 100 between their paws without the chew toy 100 rolling or slipping.

The grooves 106 and the ridges 110 mimic a tire tread pattern and provide stimulating texture to maintain a dog's interest in chewing. Preferably, the main body 102 is preferably black or dark gray to mimic tire rubber. The side surfaces 108, 112 have beveled edges to prevent oral injury to a chewing pet and the chew toy 100 has Shore A hardness rating between 80 and 95.

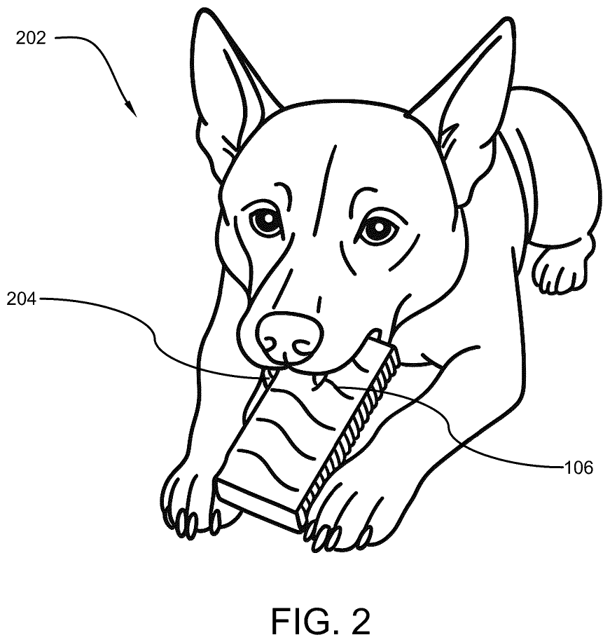

FIG. 2 illustrates a perspective view showing a dog chewing the durable chew toy of the present invention in accordance with the disclosed structure. It should be noted that toy 100 is constructed from the 100% consumable or edible rubber material to enable a dog to chew and gnaw on the toy 100 without damaging the dog's digestive system. As illustrated, the dog 202 can grip the chew toy 100 between their teeth 204 and chew for extended periods without any discomfort. The toy 100 does not include any detachable components and therefore, does not cause any oral injury or choking hazards. In some embodiments, the chew toy 100 can be infused with scents or different flavors for providing a customized taste to the pet. The grooves 106 provide support to the teeth 204 of the dog 202 for an enhanced grip and to provide better sensations to the dog.

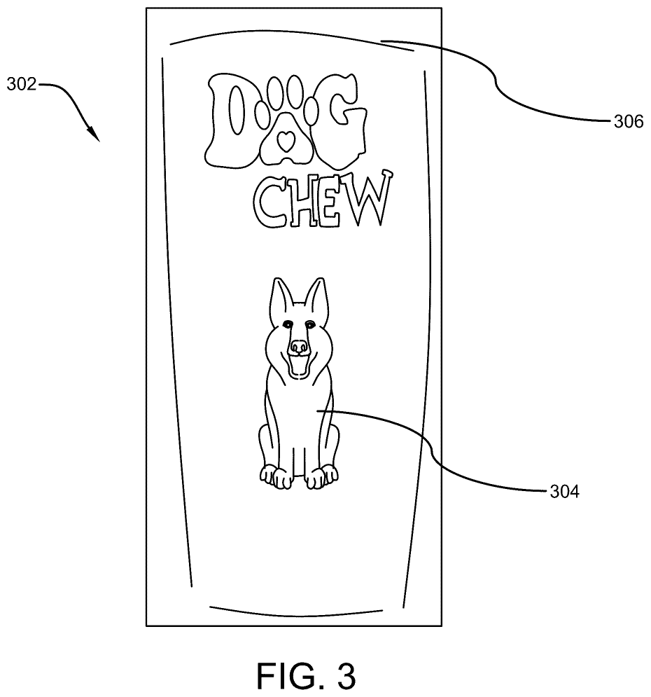

FIG. 3 illustrates a perspective view of one potential embodiment of packaging of the chew toy of the present invention in accordance with the disclosed structure. The chew toy 100 can come in a packaging 302, which is configured to store one or more chew toys. Further, the packaging 302 is made from an edible material and includes a logo or indicia 304 disposed thereon for branding and marketing. The packaging 302 includes a fastener 306, such as zip lock for enabling reuse of the packaging 302 for storing the dog chew toy 100.

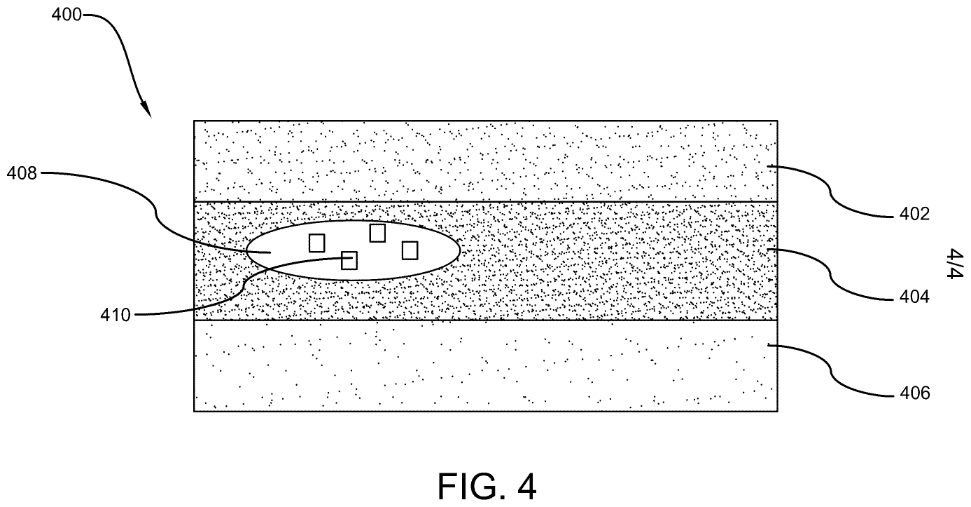

FIG. 4 illustrates a cross-sectional view of one embodiment of the durable chew toy of the present invention in accordance with the disclosed structure. In the present invention, the chew toy 400 has an outer layer 402 made of strong and durable natural rubber such as tire rubber. The outer layer 402 is non-toxic, biodegradable, and is food-grade. A middle layer 404 is a scented foam layer which is infused with various flavors such as beef, chicken, and mint. In some embodiments, the middle layer 404 may include a food flavor that is pulled through the grooves (shown in FIG. 1) for enhancing taste efficiency of the toy 400. An inner core or layer 406 is made of solid rubber and prevents the toy 400 from collapsing under pressure exerted by a pet. The inner core 406 also provides squeeze-back feel which is good for softer chewers.

The middle layer 404 may have an internal hollow chamber 408 that is configured to store a plurality of treats 410 and release an individual treat when a dog chews the toy 400. It should be noted that in other embodiments, the toy 100 can be hollow to store and release individual treats. The chew toy of all the embodiments is freezable to soothe teething puppies or for providing hot-weather relief.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “durable dog chew”, “durable dog chew toy”, “chew toy”, and “toy” are interchangeable and refer to the durable dog chew toy 100, 400 of the present invention.

Notwithstanding the foregoing, the durable dog chew toy 100, 400 of the present invention can be of any suitable configuration as is known in the art without affecting the overall concept of the invention, provided that it accomplishes the above-stated objectives. One of ordinary skill in the art will appreciate that the durable dog chew toy 100, 400 as shown in the FIGS. are for illustrative purposes only, and that many other configurations of the durable dog chew toy 100, 400 are well within the scope of the present disclosure. Although the dimensions of the durable dog chew toy 100, 400 are important design parameters for user convenience, the durable dog chew toy 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog chew toy comprising:
a body having a first major surface, a second major surface, a first side surface, and a second side surface;
wherein said body having a material of edible rubber;
wherein said edible rubber is retread tire rubber;
wherein said body having a length from 5.00 inches to 7.00 inches, a width from 0.50 inches to 1.50 inches, and a thickness from 0.50 inches to 1.50 inches;
wherein said body is rectilinear;
wherein said first major surface having a plurality of spaced, laterally oriented, sinusoidal grooves disposed therein;
wherein at least one of said first side surface and said second side surface having a plurality of uniformly spaced rectangular ridges; and
further wherein each ridge of said plurality of ridges having a width from 0.05 inch to 0.08 inch and a height from 0.06 inch to 0.09 inch.

2. The dog chew toy of claim 1, wherein said body is a solid monolithic body.

3. The dog chew toy of claim 1, wherein said body is a hollow body.

4. The dog chew toy of claim 2, wherein said first side surface and said second side surface having beveled edges.

5. The dog chew toy of claim 3, wherein said first side surface and said second side surface having beveled edges.

6. The dog chew toy of claim 4, wherein said solid monolithic body having a Shore A hardness rating between 80 and 95.

7. The dog chew toy of claim 5, wherein said hollow body having a Shore A hardness rating between 80 and 95.

8. The dog chew toy of claim 6, wherein said edible rubber is infused with flavoring.

9. The dog chew toy of claim 7, wherein said edible rubber is infused with flavoring.

10. A dog chew toy comprising:
a body having a first major surface, a second major surface, a first side surface, and a second side surface;
wherein said body having an outer layer, a middle layer, and an inner core;
wherein said outer layer having a material of food-grade natural rubber;
wherein said middle layer having a scented foam layer;
wherein said inner core having a material of solid rubber;
wherein said body is rectilinear;
wherein said first major surface having a plurality of spaced, laterally oriented, sinusoidal grooves disposed therein; and
further wherein at least one of said first side surface and said second side surface having a plurality of uniformly spaced rectangular ridges.

11. The dog chew toy of claim 10, wherein said scented foam layer infused with a flavor selected from the group consisting of a beef, a chicken, and a mint.

12. The dog chew toy of claim 10, wherein said body having a length from 5.00 inches to 7.00 inches, a width from 0.50 inches to 1.50 inches, and a thickness from 0.50 inches to 1.50 inches.

13. The dog chew toy of claim 10, wherein each ridge of said plurality of ridges having a width from 0.05 inch to 0.08 inch and a height from 0.06 inch to 0.09 inch.

14. The dog chew toy of claim 13, wherein said first side surface and said second side surface having beveled edges.

15. The dog chew toy of claim 14, wherein said outer layer having a Shore A hardness rating between 80 and 95.

16. A dog chew toy comprising:
a body having a first major surface, a second major surface, a first side surface, and a second side surface;
wherein said body having an outer layer, a middle layer, and an inner core;
wherein said outer layer having a material of food-grade natural rubber;
wherein said outer layer and said middle layer having a hollow chamber for storing a plurality of dog treats;
wherein said inner core having a material of solid rubber;
wherein said body is rectilinear;
wherein said first major surface having a plurality of spaced, laterally oriented, sinusoidal grooves disposed therein; and
further wherein at least one of said first side surface and said second side surface having a plurality of uniformly spaced rectangular ridges.

17. The dog chew toy of claim 16, wherein said body is freezable.

18. The dog chew toy of claim 16, wherein said body having a length from 5.00 inches to 7.00 inches, a width from 0.50 inches to 1.50 inches, and a thickness from 0.50 inches to 1.50 inches.

19. The dog chew toy of claim 16, wherein each ridge of said plurality of ridges having a width from 0.05 inch to 0.08 inch and a height from 0.06 inch to 0.09 inch.

20. The dog chew toy of claim 16, wherein said outer layer having a Shore A hardness rating between 80 and 95.
